(19) United States
(12) Patent Application Publication
(10) Pub. No.: US 2014/0006120 A1
(43) Pub. Date: Jan. 2, 2014

(54) MERCHANT CONTROLLED FREE BUYER DISCOUNT OFFERS INTERNET-BASED SYSTEM AND METHOD

(71) Applicants: Anthony J. Bonomini, Bountiful, UT (US); Christopher D. Patterson, Sandy, UT (US)

(72) Inventors: Anthony J. Bonomini, Bountiful, UT (US); Christopher D. Patterson, Sandy, UT (US)

(21) Appl. No.: 13/931,888

(22) Filed: Jun. 29, 2013

Related U.S. Application Data
(60) Provisional application No. 61/665,890, filed on Jun. 29, 2012.

(51) Int. Cl. G06Q 30/02

(52) U.S. Cl. CPC G06Q 30/0211
USPC 705/14.13

(57) ABSTRACT

A merchant subscribes to a pay-based automatic online marketing system and uses a virtual control dashboard to create special offers. Unlimited free virtual and printable coupons are presented online and accessed by customers and potential customers to be used in merchant business transactions. The merchant has a constantly searchable presence and has feedback about the success of other programs in related businesses and geographical areas and the analytics of the users of the program for continual updates of the special offers in real time.

### CROSS-REFERENCE TO RELATED APPLICATIONS

The present utility patent application claims the benefit of provisional patent application No. 61/665,890 filed Jun. 29, 2012.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to an Internet-based business system and, in particular, a merchant controlled marketing method to customers, using merchant established special offers and discounts and coupons presented on the Internet and other communication media for free use by the public, wherein the merchants pay various levels of subscriber fees to a service provider to authorize each merchant to input information about the merchant's business in real time and for the merchant to create presentations of details of special offers and promotions through an interview/template format, which may be a virtual dashboard control program, reviewed by the service provider and transmitted to a program for creating presentations about the merchant, merchant offerings, and merchant access, and of free special discount offers to the public for merchant products and/or services, wherein the service provider presents all of the free special discount offers of all of the subscribing merchants and free virtual coupons to the general public in any of a variety of types of communication means (including, but not limited to: an Internet based website, emails, social media, apps on mobile devices, as well as possible conventional means of promotion) at any of a variety of frequencies of presentation depending upon the level of subscriber fees, the presentations searchable by the general public on any of a variety of electronic communication devices accessing the Internet or communicating directly with the service provider by wireless communication devices or telephonically, wherein members of the general public interested in a free special discount offer of a merchant decide to be a user of the system and input analytics into the system and download a virtual coupon for the merchant product(s) and/or service(s) which may be printed out or displayed on an electronic device for presentation to the merchant for partial payment for products and/or services received by the user from the merchant, the analytics providing information for the merchants to use in refining and focusing their marketing efforts.

2. Description of Related Art

Prior art online coupon systems cost merchants too much money on each coupon. Prior art systems also cost users who pay for a coupon and if the coupon expires without using it, they lose the money spent for the coupon. This problem is related to the fact that the coupons have expiration dates.

Prior art systems do not allow control by the merchants and do not provide an ongoing promotion of the merchants' businesses. The coupons appear for specific time periods only.

Prior art systems do not provide feedback for merchants about user analytics and do not provide feedback about the performance of other such programs in the same business or geographic areas.

What is needed is a system over which the merchant has more control over the coupon program and the ability to rapidly respond to conditions to change aspects of the program and where the merchant has a constantly searchable presence before the public and the merchant has feedback about the success of other programs in related businesses and geographical areas and the analytics of the users of the program.

### BRIEF SUMMARY OF THE INVENTION

An object of the present invention is to provide a system and method over which the merchant has more control over the coupon program with a merchant virtual control dashboard for inputting data providing the ability to rapidly respond to conditions to change aspects of the program and a system where the merchant has a constantly searchable presence before the public and the merchant has feedback about the success of other programs in related businesses and geographical areas and the analytics of the users of the program who download free merchant coupons for printing and virtual coupons for display on mobile devices used in business transactions with the merchant.

In brief, the present invention provides authorized access to a Merchant Services Dashboard used by the merchant subscribers to interact with the program of the present invention accessed through the server for at least one Internet based website, which dashboard will give merchants control of their own special offers, email promotions, email blasts and analytics. It is meant to be not only interactive, but also intuitive and easy to navigate on the website and the mobile application as well. The operations we will put in the merchant's control are:
1. The ability to update business information such as contacts, hours, new locations, etc. These updates can take place in real time.
2. The ability to update parts on all of the merchant's current static offer on the site.

This will be completed through an interview/template format and once completed and submitted, will be reviewed and posted within 24 hours.
3. Ability to update payment information. This allows the merchant to update how they pay for the monthly service via credit card or ACH.
4. Ability to update photos and logos.
5. Ability to start a Facebook or other social media posting through the at least one website
6. When actively participating in an email offer, the merchant will have the ability to create the offer through an interview/template format. This will need to be completed 72 hours in advance of the offer for customer service review.
7. Contact customer support.
8. Order point of sale supplies.
9. Viewing all analytics reports.
10. Keep track of the merchant's email database.
11. View reports specific analytics for each current offer. These update and populate archived reports once the offer has been changed. This means real time offers that coincide with the actual promotion.
12. Track zip codes at a glance in numerical order.
13. Category reports that show the merchants performance vs. others within the same category nationally, regionally and locally.

An advantage of the present invention is that it provides free coupons to users.

Another advantage of the present invention is that it provides more control for the merchant.

An added advantage of the present invention is that it provides feedback to the merchant regarding comparative program effectiveness and consumer statistics.

One more advantage of the present invention is that it provides a larger percentage of income for merchants on products and/or services purchased using the coupons in the program.

### BRIEF DESCRIPTION OF THE SEVERAL VIEWS OF THE DRAWINGS

These and other details of the present invention will be described in connection with the accompanying drawings, which are furnished only by way of illustration and not in limitation of the invention, and in which drawings:

FIG. 1 is a diagrammatic view of the system of the present invention showing the major functioning elements of the invention;

FIG. 2 is a diagrammatic view of a simplified version of the merchant dashboard of FIG. 1 showing the various actions, offers and reports of a merchant program;

FIG. 3 is a diagrammatic view of a more complete version of the merchant dashboard of FIG. 1 showing the various actions, offers and reports of a merchant program;

FIG. 4 is a diagrammatic view of the analytics of FIG. 1 showing a sample of some of the possible analytics of the merchant program.

### DETAILED DESCRIPTION OF THE INVENTION

In FIGS. 1-4, a merchant controlled free buyer virtual discount offer system 20 and method comprises a method for enabling merchants to subscribe to a system for real time merchant creation of at least one free special offer 25 to customers and potential customers for special discounts and special offers and special discount coupons, the at least one free special offer presented on at least one communication media 24 for free access and free use by existing customers and potential new customers.

The method comprises:

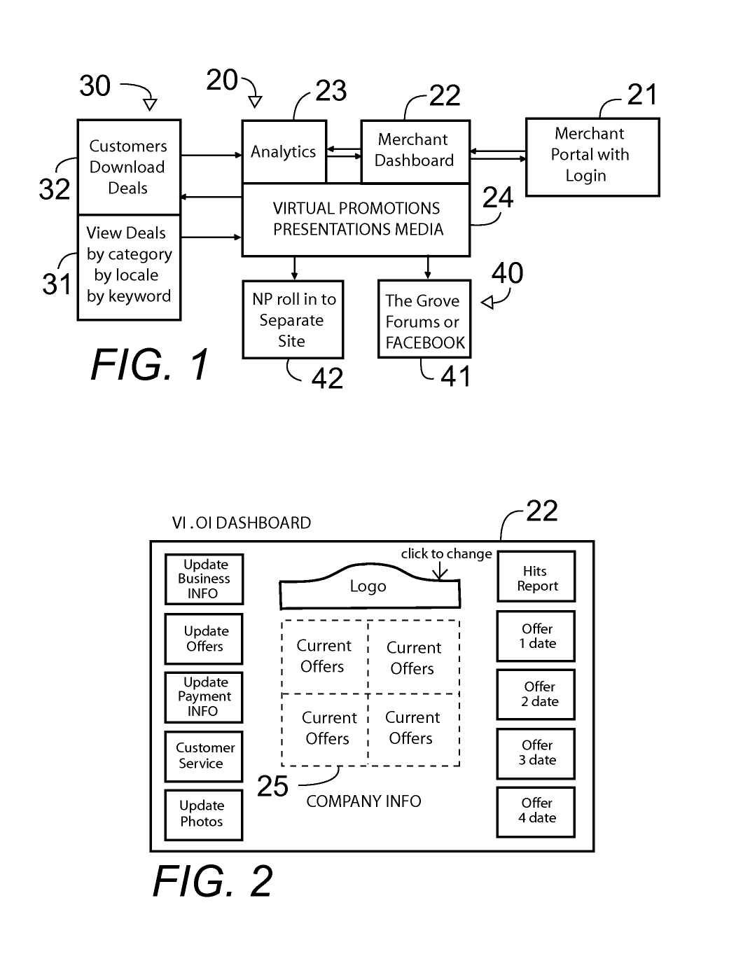

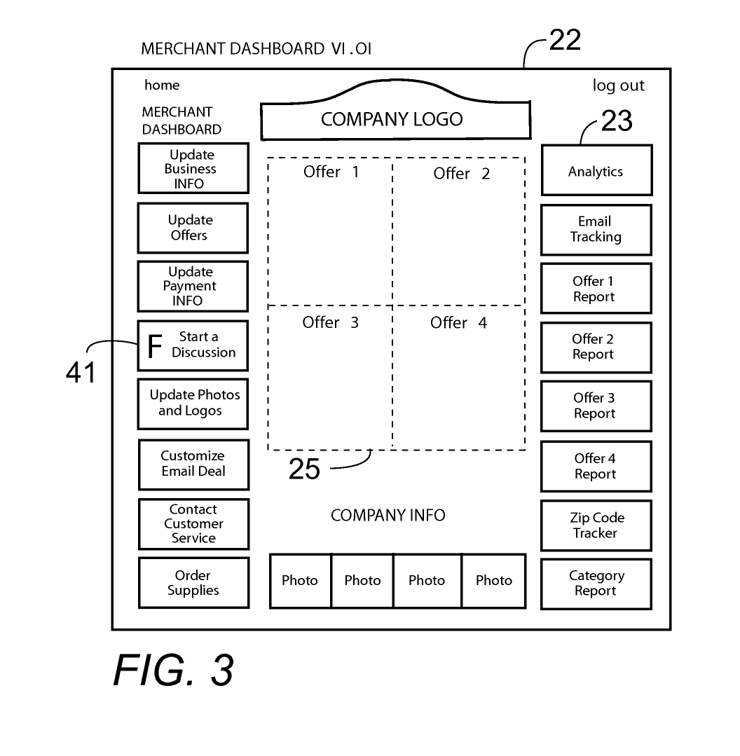

In FIG. 1, a first step comprising providing an automated programmed system 20 on at least one communication media 24 for enabling a merchant to set up at least one merchant paid subscription account with a merchant login portal 21 for the merchant to create at least one special offer 25, as shown in FIGS. 2 and 3, in real time for special discounts and special offers and special discount coupons presented for free use by the public on at least one communication media 24.

A second step comprising providing an automated electronic form and payment system for a merchant to subscribe to the automated programmed system 20 for use of the system to promote at least one merchant business by creating the at least one free special offer 25. The second step preferably comprises a merchant enrolling for use of the system for specified time intervals for specified time interval payments and for specified numbers of free special offers and for specified communication media. Further, the second step preferably comprises providing an automated electronic control panel, a virtual merchant dashboard 22, as shown in FIGS. 2 and 3, for merchant input in an interview/template format using the virtual dashboard control program 22, the merchant input being reviewed by the service provider and transmitted to a program for creating presentations about the merchant, merchant offerings, and merchant access, and of free special discount offers to the public for merchant products and services.

A third step comprising automatically presenting the merchant's at least one free special offer 25 on at least one communication media for free access and free unlimited use by existing customers and potential new customers to use the at least one special offer to engage in at least one business transaction with the merchant. This will preferably be completed through an interview/template format and once completed and submitted, will be reviewed and posted within 24 hours. When actively participating in an email offer, the merchant will have the ability to create the offer through an interview/template format to be completed 72 hours in advance of the offer to allow for provider's customer service review. This provides real time offers that coincide with the actual promotion date.

In FIGS. 2 and 3, the fourth step comprising providing an automated electronic virtual control panel, such as a merchant dashboard 22, with full merchant control to create the at least one free special offer 25, to monitor program performance analytics 23, to update merchant information in real time, and to use customer data input into the automated system to create customer focused free special offers in real time.

The third step preferably comprises presenting free special discount offers and free unlimited virtual coupons 25 of subscribing merchants to the general public in any of a variety of types of communication means taken from the list of communication means including an Internet based website, emails, social media, apps on mobile devices, and conventional means of promotion.

The third step comprises presenting the free special discount offers and the virtual free unlimited coupons of subscribing merchants to the general public at any of a variety of frequencies of presentation depending upon the level of subscriber fees.

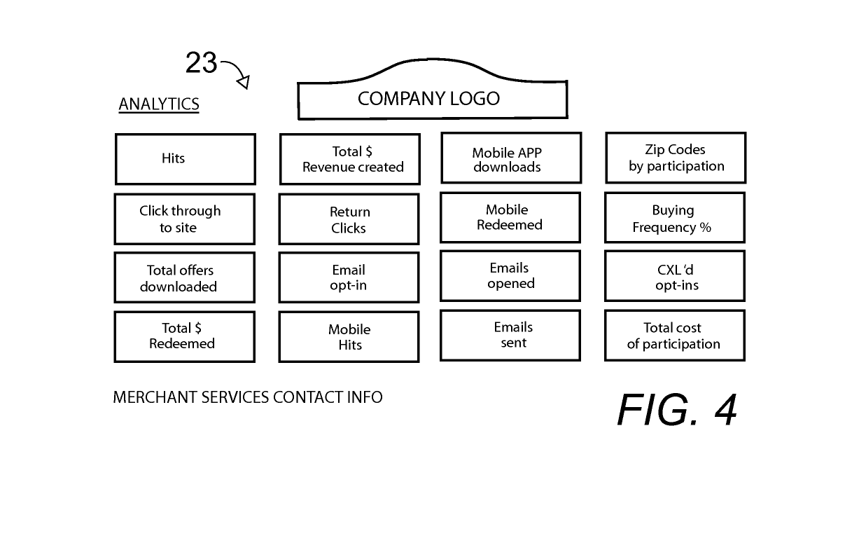

The third step further comprises the presentations being searchable by the general public 31 by a variety of subject areas including viewing discount deals by location, category, and keywords and searching on any of a variety of electronic communication devices accessing the Internet and communicating directly with a service provider by wireless communication devices or telephonically, wherein any of the members of the general public being interested in a free special discount offer of a merchant becoming a user of the system and inputting analytics into the system and downloading at least one free virtual coupon for at least one merchant business transaction, the at least one free virtual coupon being printed out or being displayed on an electronic device for presentation to the merchant for using in the at least one merchant business transaction, the analytics 23, as shown in FIG. 4, providing information for the merchant to use in refining and focusing marketing efforts.

In FIGS. 2 and 3, the fourth step comprises the virtual control panel including a merchant services virtual dashboard 22 being accessed through a server by the merchant through the merchant login portal 21 for controlling any of a variety of activities taken from the list of activities including setting up at least one Internet based website, controlling merchant special offers, creating email promotions, creating email blasts, researching and using analytics, updating merchant business information including displaying contact information, indicating hours of business, announcing any new locations, updating parts of the merchant current static offers on the website, updating payment information, updating photos and logos, starting social media postings, contacting customer support, ordering point of sale supplies, viewing all analytics reports, keeping track of merchant email database, viewing reports and specific analytics for each current offer, updating and populating archived reports once the offer has been changed, tracking zip codes at a glance in numerical order, viewing category reports comparing merchant performance with others within the same category nationally, regionally and locally.

In use, merchants subscribe automatically online to a virtual marketing service of the present invention by paying one of various levels of subscriber fees to the marketing service provider to authorize each merchant to input information about the merchant's business in real time and for presentation of details of special offers and promotions through an interview/template format through a virtual dashboard control program. The special offers are reviewed by the service provider and transmitted to a program for creating presentations about the merchant, merchant offerings, and merchant access, and of free special discount offers to the public for merchant products and/or services.

The service provider presents all of the free special discount offers of all of the subscribing merchants and virtual coupons to the general public in any of a variety of types of communication means (including, but not limited to: an individual merchant Internet based website, emails, social media, apps on mobile devices, as well as possible conventional means of promotion) and any of a variety of frequencies of presentation depending upon the level of subscriber fees.

The presentations are searchable by the general public by category, locale, and keywords on any of a variety of electronic communication devices accessing the Internet or communicating directly with the service provider by wireless communication devices or telephonically. Members of the general public interested in a free special discount offer by a merchant may decide to be a user of the system and input analytics into the system and download a virtual coupon for the merchant product(s) and/or service(s) which may be printed out or displayed on an electronic device for presentation to the merchant for partial payment for products and/or services received by the user from the merchant, the analytics providing information for the merchants to use in refining and focusing their marketing efforts.

It is understood that the preceding description is given merely by way of illustration and not in limitation of the invention and that various modifications may be made thereto without departing from the spirit of the invention as claimed.

What is claimed is:

1. A method for enabling merchants to subscribe to a system for real time merchant creation of at least one free special offer to customers and potential customers for special discounts and special offers and special discount coupons, the at least one free special offer presented on at least one communication media for free access and free use by existing customers and potential new customers, the method comprising:
a first step of providing an automated programmed system on at least one communication media for enabling a merchant to set up at least one merchant paid subscription account for the merchant to create at least one special offer in real time for special discounts and special offers and special discount coupons presented free to the public on at least one communication media;
a second step of providing an automated electronic form and payment system for a merchant to subscribe to the automated programmed system for use of the system to promote at least one merchant business by creating the at least one free special offer;
a third step of automatically presenting the merchant's at least one free special offer on at least one communication media for free access and free unlimited use by existing customers and potential new customers to use the at least one special offer to engage in at least one business transaction with the merchant;
a fourth step of providing an automated electronic virtual control panel with full merchant control to create the at least one free special offer, to monitor program performance analytics, to update merchant information in real time, and to use customer data input into the automated system to create customer focused free special offers in real time.

2. The method of claim 1 wherein the second step comprises providing an automated electronic control panel for merchant input in an interview/template format of a virtual dashboard control program, the merchant input being reviewed by the service provider and transmitted to a program for creating presentations about the merchant, merchant offerings, and merchant access, and of free special discount offers to the public for merchant products and services.

3. The method of claim 2 wherein the second step comprises enrolling for use of the system for specified time intervals for specified time interval payments and for specified numbers of free special offers and for specified communication media.

4. The method of claim 3 wherein the third step comprises presenting free special discount offers and virtual coupons of subscribing merchants to the general public in any of a variety of types of communication means taken from the list of communication means including an Internet based website, emails, social media, apps on mobile devices, and conventional means of promotion.

5. The method of claim 4 wherein the third step comprises presenting the free special discount offers and the virtual coupons of subscribing merchants to the general public at any of a variety of frequencies of presentation depending upon the level of subscriber fees.

6. The method of claim 4 wherein the third step further comprises the presentations being searchable by the general public by a variety of subject areas including viewing discount deals by location, category, and keywords on any of a variety of electronic communication devices accessing the Internet and communicating directly with a service provider by wireless communication devices or telephonically, wherein any of the members of the general public being interested in a free special discount offer of a merchant becoming a user of the system and inputting analytics into the system and downloading at least one free virtual coupon for at least one merchant business transaction, the at least one free virtual coupon being printed out or being displayed on an electronic device for presentation to the merchant for using in the at least one merchant business transaction, the analytics providing information for the merchant to use in refining and focusing marketing efforts.

7. The method of claim 1 wherein the fourth step comprises the virtual control panel including a merchant services virtual dashboard being accessed through a server by the merchant for controlling any of a variety of activities taken from the list of activities including setting up at least one Internet based website, controlling merchant special offers, creating email promotions, creating email blasts, researching and using analytics, updating merchant business information including displaying contact information, indicating hours of business, announcing any new locations, updating parts of the merchant current static offers on the website, updating payment information, updating photos and logos, starting social media postings, contacting customer support, ordering point of sale supplies, viewing all analytics reports, keeping track of merchant email database, viewing reports and specific analytics for each current offer, updating and populating archived reports once the offer has been changed, tracking zip codes at a glance in numerical order, viewing category reports comparing merchant performance with others within the same category nationally, regionally and locally.
